(19) United States
(12) Patent Application Publication
(10) Pub. No.: US 2024/0112841 A1
(43) Pub. Date: Apr. 4, 2024

(54) COIL COMPONENT

(71) Applicant: Murata Manufacturing Co., Ltd., Kyoto-fu (JP)

(72) Inventors: Kouta ONO, Nagaokakyo-shi (JP); Kouhei MATSUURA, Nagaokakyo-shi (JP); Tomoyuki SATO, Nagaokakyo-shi (JP)

(73) Assignee: Murata Manufacturing Co., Ltd., Kyoto-fu (JP)

(21) Appl. No.: 18/365,713

(22) Filed: Aug. 4, 2023

(30) Foreign Application Priority Data
Sep. 30, 2022 (JP) 2022-157834

(51) Int. Cl. H01F 17/00; H01F 27/29

(52) U.S. Cl. CPC H01F 17/0013; H01F 27/292; H01F 2017/0093

(57) ABSTRACT

A coil component includes an element body including a multilayer body in which a first ferrite layer, a first glass layer, and a second ferrite layer are laminated in that order; a coil embedded in the first glass layer; and an outer electrode provided on an outer surface of the element body and electrically connected to the coil. The first glass layer includes regions in which Cu and Mg coexist.

### CROSS-REFERENCE TO RELATED APPLICATION

This application claims benefit of priority to Japanese Patent Application No. 2022-157834, filed Sep. 30, 2022, the entire content of which is incorporated herein by reference.

### BACKGROUND

### Technical Field

The present disclosure relates to a coil component.

### Background Art

Japanese Unexamined Patent Application Publication No. 2021-86981 describes a coil component including an element body, a coil, and an outer electrode. The element body includes a first glass layer, a first ferrite layer provided on a first principal surface of the first glass layer, and a second ferrite layer provided on a second principal surface of the first glass layer. The coil is embedded in the first glass layer. The outer electrode is provided on a side surface of the element body and extends along the first ferrite layer, the first glass layer, and the second ferrite layer. In plan view of the side surface of the element body viewed in a direction perpendicular to the side surface, a width of the outer electrode in regions of the ferrite layers is greater than a width of the outer electrode in a region of the glass layer.

The coil component described in Japanese Unexamined Patent Application Publication No. 2021-86981 has a structure including the pair of ferrite layers, each ferrite layer being disposed on one of the principal surfaces of the glass layer in which the coil is embedded. In this coil component, when the element body in an unfired state is fired, a Cu component contained in the ferrite layers is diffused into the glass layer. When a base electrode that constitutes the outer electrode is baked, the Cu component diffused in the glass layer may move to an outer surface of the glass layer and be deposited on the outer surface of the glass layer. When a plating electrode that constitutes the outer electrode is formed, the Cu component deposited on the outer surface of the glass layer may cause a defect referred to as “plating elongation” in which the plating electrode protrudes from an intended location.

### SUMMARY

The present disclosure provides a coil component in which movement of a Cu component toward an outer surface of a glass layer can be reduced.

A coil component of the present disclosure includes an element body including a multilayer body in which a first ferrite layer, a first glass layer, and a second ferrite layer are laminated in that order; a coil embedded in the first glass layer; and an outer electrode provided on an outer surface of the element body and electrically connected to the coil. The first glass layer includes regions in which Cu and Mg coexist.

The present disclosure provides a coil component in which movement of a Cu component toward an outer surface of a glass layer can be reduced.

### BRIEF DESCRIPTION OF THE DRAWINGS

FIG. 1 is a schematic perspective view of an example of a coil component according to a first embodiment of the present disclosure;

FIG. 2 is a WT sectional view of the coil component illustrated in FIG. 1;

FIG. 3 is an exploded perspective view of the coil component illustrated in FIG. 1 (from which outer electrodes are removed);

FIG. 4 is a schematic perspective view of an example of a coil component according to a second embodiment of the present disclosure; and

FIG. 5 is a WT sectional view of the coil component illustrated in FIG. 4.

### DETAILED DESCRIPTION

Coil components according to the present disclosure will now be described. The present disclosure is not limited to configurations described below, and changes may be made as appropriate without departing from the gist of the present disclosure. Combinations of preferred configurations described below are also included in the present disclosure.

It is needless to say that each of the embodiments described below is an exemplification and that configurations in different embodiments may be partly replaced or combined with each other. In the second and following embodiments, description of features that are the same as those of the first embodiment will be omitted, and differences will be mainly described. In particular, the same or similar effects obtained by the same or similar configurations will not be described in each embodiment.

In the following description, when the embodiments are not particularly distinguished from each other, a coil component of each embodiment may be referred to simply as a “coil component of the present disclosure”.

In each of the embodiments described below, a common-mode choke coil will be described as an example of a coil component of the present disclosure. The coil component of the present disclosure may be a coil component other than a common-mode choke coil.

Diagrams referred to below are schematic, and scales of dimensions, aspect ratios, and the like may differ from those of actual products.

In this specification, terms representing the relationships between elements (for example, “parallel” and “orthogonal”) and terms representing the shapes of elements are to be interpreted not only in a strict literal sense but also as including substantially equivalent ranges, for example, ranges with a tolerance of several percent.

### First Embodiment

A coil component according to a first embodiment of the present disclosure includes an element body. The element body includes a multilayer body in which a first ferrite layer, a first glass layer, and a second ferrite layer are laminated in that order.

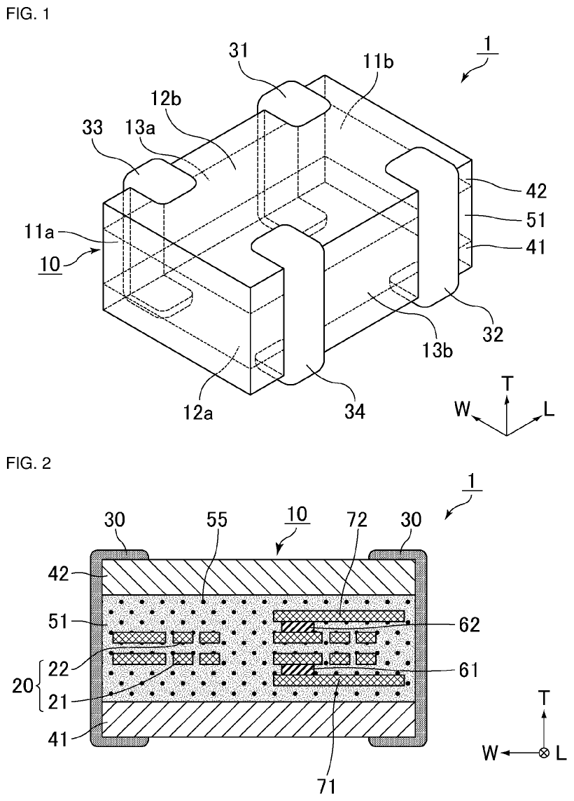

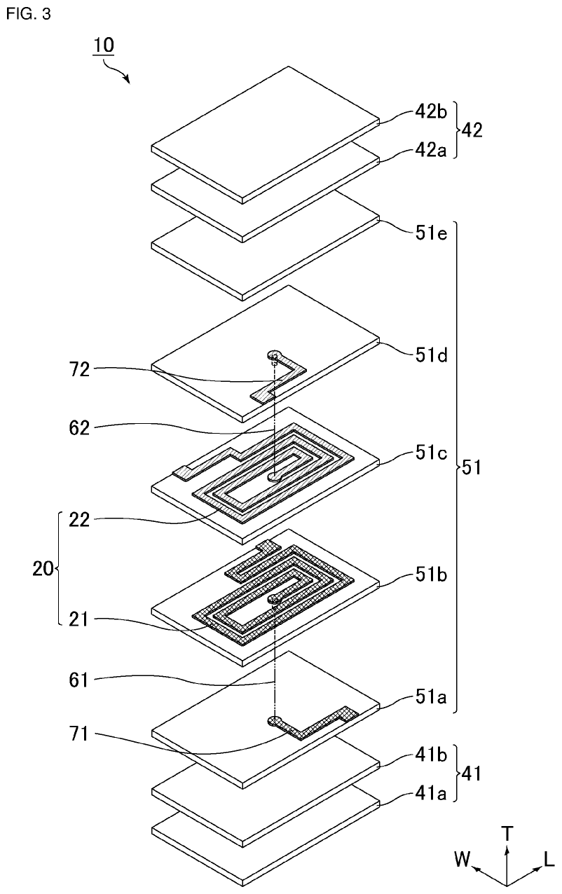

FIG. 1 is a schematic perspective view of an example of a coil component according to a first embodiment of the present disclosure. FIG. 2 is a WT sectional view of the coil component illustrated in FIG. 1. FIG. 3 is an exploded perspective view of the coil component illustrated in FIG. 1 (from which outer electrodes are removed).

A coil component 1 illustrated in FIG. 1 is a common-mode choke coil, and includes an element body 10, coils 20 (see FIGS. 2 and 3), and outer electrodes 30 (see FIG. 2). The coils 20 are embedded in the element body 10. The outer electrodes 30 are provided on an outer surface of the element body 10 and electrically connected to the coils 20.

In this specification, a length direction, a height direction, and a width direction are defined as directions denoted by L, T, and W, respectively, as illustrated in FIG. 1 and other figures. The length direction L, the height direction T, and the width direction W are orthogonal to each other.

The element body 10 is, for example, rectangular-parallelepiped-shaped or substantially rectangular-parallelepiped-shaped. The element body 10 includes a first end surface 11a and a second end surface 11b opposite to each other in the length direction L; a first principal surface 12a and a second principal surface 12b opposite to each other in the height direction T; and a first side surface 13a and a second side surface 13b opposite to each other in the width direction W.

The element body 10 may include corner portions and edge portions that are rounded. Each corner portion of the element body 10 is a portion at which three sides of the element body 10 meet. Each edge portion of the element body 10 is a portion at which two sides of the element body 10 meet.

The element body 10 includes a multilayer body in which a first ferrite layer 41, a first glass layer 51, and a second ferrite layer 42 are laminated in that order. In the example illustrated in FIGS. 1, 2, and 3, the first ferrite layer 41, the first glass layer 51, and the second ferrite layer 42 are laminated in the height direction T.

In other words, the element body 10 includes the first glass layer 51 and the first and second ferrite layers 41 and 42 between which the first glass layer 51 is disposed in the lamination direction (height direction T in this example). In other words, in the lamination direction (height direction T in this example), the first ferrite layer 41 is disposed on one principal surface of the first glass layer 51, and the second ferrite layer 42 is disposed on the other principal surface of the first glass layer 51.

The first glass layer 51 includes regions 55 (see FIG. 2) in which Cu and Mg coexist. In the present disclosure, a state in which Cu and Mg coexist may be a state in which Cu and Mg are present in a mixed state in regions such as the regions 55, or a state in which Cu and Mg are present in a separate state in these regions. The regions in which Cu and Mg coexist may, although not necessarily, include substances other than Cu and Mg. It can be said that “Cu and Mg coexist” when element mapping by FE-WDX described below shows that regions in which a Cu component is present and regions in which a Mg component is present overlap or are close to each other in the same region.

When the element body 10 in an unfired state is fired, the Cu component contained in the first ferrite layer 41 and the second ferrite layer 42 is diffused into the first glass layer 51. However, since the first glass layer 51 includes the regions 55 in which Cu and Mg coexist, movement of the Cu component toward an outer surface of the first glass layer 51 is reduced. As a result, when base electrodes that constitute the outer electrodes 30 are subjected to baking, deposition of the Cu component on the outer surface of the first glass layer 51 is reduced. Therefore, even when plating electrodes that also constitute the outer electrodes 30 are formed, the occurrence of plating elongation can be reduced.

The Cu component and the Mg component contained in the first glass layer 51 can be observed by performing element mapping by field emission wavelength-dispersive X-ray spectrometry (FE-WDX). A second glass layer 52 and a third glass layer 53 described below can also be observed by performing element mapping as described above.

The regions 55 in which Cu and Mg coexist are preferably scattered over the first glass layer 51. The regions 55 in which Cu and Mg coexist are uniformly scattered over the first glass layer 51 in FIG. 2, but may be non-uniformly scattered over the first glass layer 51.

The sizes, shapes, etc. of the regions 55 in which Cu and Mg coexist are not particularly limited. However, a maximum width of the regions 55 in which Cu and Mg coexist is preferably 5 μm or less, more preferably 4 μm or less. The maximum width of the regions 55 in which Cu and Mg coexist is, for example, 0.5 μm or more.

The maximum width of the regions 55 in which Cu and Mg coexist may be determined by performing the above-described element mapping by FE-WDX from the sizes of portions in which the Cu component and the Mg component are both present. The regions 55 in which Cu and Mg coexist are preferably observed on a cross section (WT cross section) obtained by, for example, grinding the sample illustrated in FIG. 1 in the length direction L to a depth such that a substantially central portion of the sample in the length direction L is exposed. The same cross section may be used to observe the second glass layer 52 and the third glass layer 53 described below.

The regions 55 in which Cu and Mg coexist are preferably present near an interface between the first ferrite layer 41 and the first glass layer 51. More specifically, the regions 55 in which Cu and Mg coexist are preferably present within a distance of ⅕ or less of the thickness of the first glass layer 51 from the interface between the first ferrite layer 41 and the first glass layer 51, for example, within a distance of 20 μm or less from the interface between the first ferrite layer 41 and the first glass layer 51. Similarly, the regions 55 in which Cu and Mg coexist are preferably present near an interface between the second ferrite layer 42 and the first glass layer 51. More specifically, the regions 55 in which Cu and Mg coexist are preferably present within a distance of ⅕ or less of the thickness of the first glass layer 51 from the interface between the second ferrite layer 42 and the first glass layer 51, for example, within a distance of 20 μm or less from the interface between the second ferrite layer 42 and the first glass layer 51. The regions 55 in which Cu and Mg coexist may, although not necessarily, be present at locations beyond the above-described distances, for example, around the center of the first glass layer 51 in the thickness direction.

The first glass layer 51 contains, for example, at least B, Si, and Mg. The first glass layer 51 preferably contains K in addition to B, Si, and Mg. The first glass layer 51 may contain elements other than the above-described elements, for example, Al.

The first glass layer 51 may contain at least forsterite.

The first glass layer 51 preferably contains a glass material. The glass material contained in the first glass layer 51 preferably contains at least K, B, and Si. More preferably, the glass material contains 0.5% by weight or more and 5% by weight or less (i.e., from 0.5% by weight to 5% by weight) of K in terms of K₂O content; 10% by weight or more and 25% by weight or less (i.e., from 10% by weight to 25% by weight) of B in terms of B₂O₃ content; 70% by weight or more and 85% by weight or less (i.e., from 70% by weight to 85% by weight) of Si in terms of SiO₂ content; and 0% by weight or more and 5% by weight or less (i.e., from 0% by weight to 5% by weight) of Al in terms of Al₂O₃ content.

The first glass layer 51 may contain a filler in addition to the glass material. In such a case, the filler contained in the first glass layer 51 preferably contains forsterite (2MgO·SiO₂). The filler contained in the first glass layer 51 preferably contains at least one of quartz (SiO₂) and alumina (Al₂O₃) in addition to forsterite. In particular, the filler contained in the first glass layer 51 preferably contains quartz, alumina, and forsterite.

The first glass layer 51 is preferably made of a glass-ceramic material containing a glass material and a filler.

When the glass-ceramic material contains forsterite as a filler, the glass-ceramic material preferably contains 5% by volume or more and 15% by volume or less (6% by weight or more and 14% by weight or less) of forsterite.

When the total amount of the glass-ceramic material is 100% by weight, preferably, the glass-ceramic material contains 8% by weight or more and 12% by weight or less (i.e., from 8% by weight to 12% by weight) of B in terms of B₂O₃ content; 2% by weight or more and 3% by weight or less (i.e., from 2% by weight to 3% by weight) of Al in terms of Al₂O₃ content; 70% by weight or more and 85% by weight or less (i.e., from 70% by weight to 85% by weight) of Si in terms of SiO₂ content; 0.5% by weight or more and 1.5% by weight or less (i.e., from 0.5% by weight to 1.5% by weight) of K in terms of K₂O content; and 3% by weight or more and 10% by weight or less (i.e., from 3% by weight to 10% by weight) of Mg in terms of MgO content.

The thickness (dimension in the height direction T) of the first glass layer 51 is, for example, 20 μm or more and 300 μm or less (i.e., from 20 μm to 300 μm), preferably 30 μm or more and 200 μm or less (i.e., from 30 μm to 200 μm).

The first ferrite layer 41 and the second ferrite layer 42 may be made of the same ferrite material or different ferrite materials. Preferably, the first ferrite layer 41 and the second ferrite layer 42 are made of the same ferrite material.

The ferrite material contains, for example, Fe, Zn, Cu, and Ni as main components. The ferrite material may also contain additives, such as Mn₃O₄ Co₃O₄, SnO₂, Bi₂O₃, and SiO₂ in addition to the above-described main components. The ferrite material may also include unavoidable impurities. As long as the ferrite material of at least one of the first ferrite layer 41 and the second ferrite layer 42 contains Cu, the ferrite material of the other ferrite layer may, although not necessarily, contain Cu.

Preferably, the ferrite material of each of the first ferrite layer 41 and the second ferrite layer 42 contains 40 mol % or more and 49.5 mol % or less (i.e., from 40 mol % to 49.5 mol %) of Fe in terms of Fe₂O₃ content, 5 mol % or more and 35 mol % or less (i.e., from 5 mol % to 35 mol %) of Zn in terms of ZnO content, 6 mol % or more and 12 mol % or less (i.e., from 6 mol % to 12 mol %) of Cu in terms of CuO content, and 8 mol % or more and 40 mol % or less (i.e., from 8 mol % to 40 mol %) of Ni in terms of NiO content.

The thickness (dimension in the height direction T) of the first ferrite layer 41 may be the same as or different from the thickness (dimension in the height direction T) of the second ferrite layer 42. The thickness of the first ferrite layer 41 may be the same as the thickness of the first glass layer 51, less than the thickness of the first glass layer 51, or greater than the thickness of the first glass layer 51. Similarly, the thickness of the second ferrite layer 42 may be the same as the thickness of the first glass layer 51, less than the thickness of the first glass layer 51, or greater than the thickness of the first glass layer 51.

The glass layer and the ferrite layers are distinguished from each other as follows. First, the periphery of the coil component is sealed with resin as necessary, and then the coil component is ground in a first direction (for example, the length direction) orthogonal to the lamination direction (for example, the height direction). Thus, a cross section extending in the lamination direction and a second direction (for example, the width direction) orthogonal to the lamination direction and the first direction is exposed at a substantially central location in the first direction. Next, a region expected to include different layers on the exposed cross section of the element body (for example, a region expected to include different layers based on a difference in color tone or the like) is observed by scanning transmission electron microscopy-energy dispersive X-ray spectrometry (STEM-EDX) to determine the composition (content ratios of detected elements). The thus-obtained composition is used to determine whether the constituent material of each layer is a glass-ceramic material or a ferrite material. Thus, the glass layer and the ferrite layers are distinguished from each other.

The coils 20 include, for example, a first coil 21 and a second coil 22. The number of coils 20 is not limited to two, and may be one or three or more.

In FIG. 2, the first coil 21 and the second coil 22 are embedded in the first glass layer 51. The first coil 21 and the second coil 22 are insulated from each other.

The first coil 21 and the second coil 22 are successively arranged in the lamination direction of the element body 10 (height direction T in this example) and constitute a common-mode choke coil.

The coils 20 including the first coil 21 and the second coil 22 are made of, for example, a conductive material, such Ag or Cu. The conductive material of the coils 20 is preferably Ag. Thus, the coils 20 preferably contain at least Ag.

As illustrated in FIG. 3, the first coil 21 and the second coil 22 have spiral patterns that are spirally wound in the same direction when viewed in the lamination direction (height direction T in this example). The coils 20 including the first coil 21 and the second coil 22 are electrically connected to respective ones of the outer electrodes 30.

More specifically, one end of the first coil 21 at the outer periphery of the spiral pattern extends to the outer surface of the element body 10. The other end of the first coil 21 at the center of the spiral pattern is connected to one end of a first extended conductor 71 by a first via conductor 61 provided in the first glass layer 51. The other end of the first extended conductor 71 extends to the outer surface of the element body 10.

Similarly, one end of the second coil 22 at the outer periphery of the spiral pattern extends to the outer surface of the element body 10. The other end of the second coil 22 at the center of the spiral pattern is connected to one end of a second extended conductor 72 by a second via conductor 62 provided in the first glass layer 51. The other end of the second extended conductor 72 extends to the outer surface of the element body 10.

The outer electrodes 30 include, for example, a first outer electrode 31, a second outer electrode 32, a third outer electrode 33, and a fourth outer electrode 34. The number of outer electrodes 30 is not limited to four (that is, two pairs), and may be changed in accordance with the number of coils 20. Therefore, the number of outer electrodes 30 may be two (that is, one pair) or three or more, for example, six (that is, three pairs).

The outer electrodes 30 are electrically connected to the coils 20. Referring to FIGS. 2 and 3, one end of the first coil 21 extends to the outer surface of the element body 10 and is connected to the first outer electrode 31. The other end of the first coil 21 is connected to the second outer electrode 32 by the first extended conductor 71 extending to the outer surface of the element body 10. Similarly, one end of the second coil 22 extends to the outer surface of the element body 10 and is connected to the third outer electrode 33. The other end of the second coil 22 is connected to the fourth outer electrode 34 by the second extended conductor 72 extending to the outer surface of the element body 10.

Each of the outer electrodes 30 is provided on the outer surface of the element body 10 to extend along the first ferrite layer 41, the first glass layer 51, and the second ferrite layer 42. In FIG. 1, the first outer electrode 31 and the third outer electrode 33 are provided on the first side surface 13a of the element body 10, and the second outer electrode 32 and the fourth outer electrode 34 are provided on the second side surface 13b of the element body 10. As illustrated in FIG. 1, each of the first outer electrode 31, the second outer electrode 32, the third outer electrode 33, and the fourth outer electrode 34 may be U-shaped (bracket shaped) and extend to the first principal surface 12a and the second principal surface 12b of the element body 10.

As illustrated in FIG. 1, two or more of the outer electrodes 30 may be arranged next to each other on one surface of the element body 10. In the example illustrated in FIG. 1, the first outer electrode 31 and the third outer electrode 33 are arranged next to each other on the first side surface 13a of the element body 10, and the second outer electrode 32 and the fourth outer electrode 34 are arranged next to each other on the second side surface 13b of the element body 10.

Each outer electrode 30 includes, for example, a base electrode and a plating electrode provided on the base electrode. The plating electrode may include one layer or two or more layers. Each outer electrode 30 preferably contains at least Ag.

When each outer electrode 30 includes the base electrode and the plating electrode, the base electrode is preferably a base electrode containing Ag and Cu, and more preferably a base electrode containing Ag. The plating electrode preferably includes one or both of a Ni plating electrode and a Sn plating electrode, and preferably includes both a Ni plating electrode and a Sn plating electrode. In particular, each outer electrode 30 preferably includes a base electrode containing Ag, a Ni plating electrode provided on the base electrode, and a Sn plating electrode provided on the Ni plating electrode.

The coil component 1 may be manufactured by, for example, the following method.

Step of Producing Glass-Ceramic Material

For example, K₂O, B₂O₃, SiO₂, and Al₂O₃ are weighed in a predetermined ratio and mixed in, for example, a crucible made of platinum.

Next, the resulting mixture is heated and melted. The heating temperature may be, for example, 1500° C. or more and 1600° C. or less (i.e., from 1500° C. to 1600° C.).

After that, the resulting melted mixture is rapidly cooled to produce a glass material.

The glass material preferably contains at least K, B, and Si. More preferably, the glass material contains 0.5% by weight or more and 5% by weight or less (i.e., from 0.5% by weight to 5% by weight) of K in terms of K₂O content; 10% by weight or more and 25% by weight or less (i.e., from 10% by weight to 25% by weight) of B in terms of B₂O₃ content; 70% by weight or more and 85% by weight or less (i.e., from 70% by weight to 85% by weight) of Si in terms of SiO₂ content; and 0% by weight or more and 5% by weight or less (i.e., from 0% by weight to 5% by weight) of Al in terms of Al₂O₃ content.

Next, the glass material is crushed to prepare glass powder. The glass powder has a median diameter D₅₀ of, for example, 1 μm or more and 3 μm or less (i.e., from 1 μm to 3 μm). Quartz powder, alumina powder, and forsterite powder, for example, are prepared as fillers. The quartz powder and the alumina powder have a median diameter D₅₀ of, for example, 0.5 μm or more and 2.0 μm or less (i.e., from 0.5 μm to 2.0 μm). The forsterite powder has a median diameter D₉₀ of, for example, 10 μm or less. The median diameter D₅₀ of the glass powder, the quartz powder, and the alumina powder is a particle size at which the volume-based cumulative probability is 50%. The median diameter D₉₀ of the forsterite powder is a particle size at which the volume-based cumulative probability is 90%.

The quartz powder, the alumina powder, and the forsterite powder are added to the glass powder as fillers. Thus, a glass-ceramic material (non-magnetic material) is produced.

Step of Producing Glass-Ceramic Sheets

The resulting glass-ceramic material, an organic binder, such as a polyvinyl butyral-based resin, an organic solvent, such as ethanol or toluene, a plasticizer, etc., are introduced into a ball mill together with PSZ media, and are mixed to produce a glass-ceramic slurry.

Next, the glass-ceramic slurry is formed into a sheet shape with a predetermined thickness by, for example, a doctor blade method, and then a punching process is performed to produce glass-ceramic sheets having a predetermined shape. The thickness of the glass-ceramic sheets is, for example, 20 μm or more and 30 μm or less (i.e., from 20 μm to 30 μm). The shape of the glass-ceramic sheets is, for example, rectangular.

Step of Producing Ferrite Material

For example, Fe₂O₃, ZnO, CuO, and NiO, for example, are weighed in a predetermined ratio. Additives such as Mn₃O₄, Co₃O₄, SnO₂, Bi₂O₃, and SiO₂ may be added.

Next, the weighed substances, pure water, a dispersant, etc., are introduced into a ball mill together with PSZ media and mixed. Then, the mixture is crushed.

The crushed mixture is dried and calcined. The calcination temperature is, for example, 700° C. or more and 800° C. or less (i.e., from 700° C. to 800° C.). The calcination time is, for example, 2 or more and 3 or less hours (i.e., from 2 to 3 hours).

Thus, a powdered ferrite material (magnetic material) is produced.

Preferably, the ferrite material contains 40 mol % or more and 49.5 mol % or less (i.e., from 40 mol % to 49.5 mol %) of Fe in terms of Fe₂O₃ content, 5 mol % or more and 35 mol % or less (i.e., from 5 mol % to 35 mol %) of Zn in terms of ZnO content, 6 mol % or more and 12 mol % or less (i.e., from 6 mol % to 12 mol %) of Cu in terms of CuO content, and 8 mol % or more and 40 mol % or less (i.e., from 8 mol % to 40 mol %) of Ni in terms of NiO content.

Step of Producing Ferrite Sheets

The resulting powdered ferrite material, an organic binder, such as polyvinyl butyral-based resin, an organic solvent, such as ethanol or toluene, etc., are introduced into a ball mill together with PSZ media and mixed. Then, the mixture is crushed to produce a ferrite slurry.

Next, the ferrite slurry is formed into a sheet shape with a predetermined thickness by, for example, a doctor blade method, and then a punching process is performed to produce ferrite sheets having a predetermined shape. The shape of the ferrite sheets is, for example, rectangular.

Step of Forming Conductor Patterns

A conductive paste, such as Ag paste, is applied to predetermined glass-ceramic sheets by, for example, screen printing to form conductor patterns for coil conductors corresponding to the first coil 21 and the second coil 22 illustrated in FIG. 3; conductor patterns for via conductors corresponding to the first via conductor 61 and the second via conductor 62 illustrated in FIG. 3; and conductor patterns for extended conductors corresponding to the first extended conductor 71 and the second extended conductor 72 illustrated in FIG. 3. The conductor patterns for via conductors are formed by irradiating the glass-ceramic sheets with laser to form via holes at predetermined positions in advance, and then filling the via holes with the conductive paste.

Step of Producing Multilayer Body Block

For example, the glass-ceramic sheets on which the conductor patterns are formed are stacked in a lamination direction (height direction T in this example) in the order of glass-ceramic sheets 51a, 51b, 51c, and 51d illustrated in FIG. 3. As illustrated in FIG. 3, a glass-ceramic sheet 51e having no conductor pattern is stacked on one principal surface of the obtained multilayer body in the lamination direction (height direction T in this example). Although not illustrated in FIG. 3, another glass-ceramic sheet having no conductor pattern may be stacked on the other principal surface of the obtained multilayer body in the lamination direction (height direction T in this example). The number of glass-ceramic sheets having no conductor pattern is not particularly limited.

Next, a predetermined number of ferrite sheets are stacked on each principal surface of the obtained multilayer body of the glass-ceramic sheets in the lamination direction (height direction T in this example). First ferrite sheets are stacked on one principal surface of the multilayer body of the glass-ceramic sheets, and second ferrite sheets are stacked on the other principal surface. For example, as illustrated in FIG. 3, first ferrite sheets 41a and 41b are stacked on one principal surface of the multilayer body of the glass-ceramic sheets, and second ferrite sheets 42a and 42b are stacked on the other principal surface.

The obtained multilayer body of the glass-ceramic sheets and the ferrite sheets is subjected to pressure bonding by, for example, a warm isostatic pressing (WIP) process to produce a multilayer body block.

Step of Producing Element Body and Coils

First, the multilayer body block is cut into pieces having a predetermined size by using a dicer or the like. Thus, separate chips are produced.

Next, the separate chips are fired. The firing atmosphere is preferably a low-oxygen atmosphere. In such a case, the oxygen concentration in the firing atmosphere is preferably 5% by volume or less. To ensure sufficient sinterability of the ferrite material, the oxygen concentration in the firing atmosphere is preferably 0.1% by volume or more. The firing temperature may be, for example, 860° C. or more and 920° C. or less (i.e., from 860° C. to 920° C.). The firing time may be, for example, 1 or more and 2 or less hours (i.e., from 1 to 2 hours).

Thus, for example, the element body 10 and the coils 20 are produced. The element body 10 includes the multilayer body in which the first ferrite layer 41, the first glass layer 51, and the second ferrite layer 42 are laminated in that order. The coils 20 include the first coil 21 and the second coil 22 embedded in the first glass layer 51.

The element body 10 may, for example, be placed in a rotating barrel together with media, and subjected to barrel grinding so that corner portions and edge portions of the element body 10 are rounded.

Step of Forming Outer Electrodes

For example, a conductive paste, such as a paste containing Ag and glass frit, is applied to the element body 10 at least at a total of four locations including two locations on the first side surface 13a of the element body 10 and two locations on the second side surface 13b of the element body 10.

Next, the applied paste is baked so that base electrodes are formed on the outer surface of the element body 10.

Then, plating electrodes, for example, a Ni plating electrode and a Sn plating electrode, are successively formed on the surface of each base electrode by, for example, electrolytic plating.

Thus, the outer electrodes 30 including the base electrodes and the plating electrodes are formed on the outer surface of the element body 10.

Thus, the coil component 1 is manufactured.

### Second Embodiment

A coil component according to a second embodiment of the present disclosure includes an element body additionally including a second glass layer on an outer side portion of a first ferrite layer and a third glass layer on an outer side portion of a second ferrite layer. The second embodiment of the present disclosure differs from the first embodiment of the present disclosure in that the element body includes the second glass layer and the third glass layer. Therefore, only structures that differ from those in the first embodiment will be described below. In the second embodiment, structures that are the same as those in the first embodiment are denoted by the same reference signs, and description thereof is thus omitted.

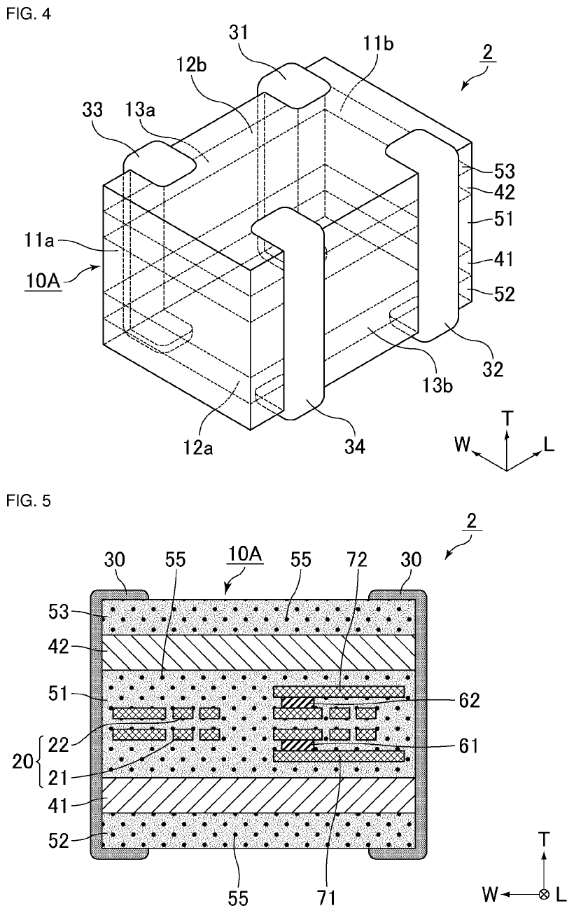

FIG. 4 is a schematic perspective view of an example of a coil component according to the second embodiment of the present disclosure. FIG. 5 is a WT sectional view of the coil component illustrated in FIG. 4.

A coil component 2 illustrated in FIG. 4 includes an element body 10A, coils 20 (see FIG. 5), and outer electrodes 30 (see FIG. 5). The coils 20 are embedded in the element body 10A. The outer electrodes 30 are provided on an outer surface of the element body 10A and electrically connected to the coils 20.

The element body 10A includes a multilayer body in which a first ferrite layer 41, a first glass layer 51, and a second ferrite layer 42 are laminated in that order. In the example illustrated in FIGS. 4 and 5, the first ferrite layer 41, the first glass layer 51, and the second ferrite layer 42 are laminated in the height direction T.

In other words, the element body 10A includes the first glass layer 51 and the first and second ferrite layers 41 and 42 between which the first glass layer 51 is disposed in the lamination direction (height direction T in this example). In other words, in the lamination direction (height direction T in this example), the first ferrite layer 41 is disposed on one principal surface of the first glass layer 51, and the second ferrite layer 42 is disposed on the other principal surface of the first glass layer 51.

The first glass layer 51 includes regions 55 (see FIG. 5) in which Cu and Mg coexist.

The regions 55 in which Cu and Mg coexist are preferably scattered over the first glass layer 51. The regions 55 in which Cu and Mg coexist are uniformly scattered over the first glass layer 51 in FIG. 5, but may be non-uniformly scattered over the first glass layer 51.

The sizes, shapes, etc. of the regions 55 in which Cu and Mg coexist are not particularly limited. However, a maximum width of the regions 55 in which Cu and Mg coexist is preferably 5 μm or less, more preferably 4 μm or less. The maximum width of the regions 55 in which Cu and Mg coexist is, for example, 0.5 μm or more.

The regions 55 in which Cu and Mg coexist are preferably present near an interface between the first ferrite layer 41 and the first glass layer 51. More specifically, the regions 55 in which Cu and Mg coexist are preferably present within a distance of ⅕ or less of the thickness of the first glass layer 51 from the interface between the first ferrite layer 41 and the first glass layer 51, for example, within a distance of 20 μm or less from the interface between the first ferrite layer 41 and the first glass layer 51. Similarly, the regions 55 in which Cu and Mg coexist are preferably present near an interface between the second ferrite layer 42 and the first glass layer 51. More specifically, the regions 55 in which Cu and Mg coexist are preferably present within a distance of ⅕ or less of the thickness of the first glass layer 51 from the interface between the second ferrite layer 42 and the first glass layer 51, for example, within a distance of 20 μm or less from the interface between the second ferrite layer 42 and the first glass layer 51. The regions 55 in which Cu and Mg coexist may, although not necessarily, be present at locations beyond the above-described distances, for example, around the center of the first glass layer 51 in the thickness direction.

The element body 10A further includes the second glass layer 52 on the outer side portion of the first ferrite layer 41 and the third glass layer 53 on the outer side portion of the second ferrite layer 42.

In other words, the element body 10A includes the multilayer body in which the second glass layer 52, the first ferrite layer 41, the first glass layer 51, the second ferrite layer 42, and the third glass layer 53 are laminated in that order.

The regions 55 in which Cu and Mg coexist (see FIG. 5) may, although not necessarily, be present in at least one of the second glass layer 52 and the third glass layer 53 in addition to the first glass layer 51. The regions 55 in which Cu and Mg coexist may be present only in the first glass layer 51; in the first glass layer 51 and the second glass layer 52; in the first glass layer 51 and the third glass layer 53; or in the first glass layer 51, the second glass layer 52, and the third glass layer 53.

When the regions 55 in which Cu and Mg coexist are present in the second glass layer 52, the regions 55 in which Cu and Mg coexist are preferably scattered over the second glass layer 52. The regions 55 in which Cu and Mg coexist are uniformly scattered over the second glass layer 52 in FIG. 5, but may be non-uniformly scattered over the second glass layer 52.

When the regions 55 in which Cu and Mg coexist are present in the second glass layer 52, the sizes, shapes, etc. of the regions 55 in which Cu and Mg coexist are not particularly limited. However, a maximum width of the regions 55 in which Cu and Mg coexist is preferably 5 μm or less, more preferably 4 μm or less. A maximum width of the regions 55 in which Cu and Mg coexist is, for example, 0.5 μm or more. The maximum width of the regions 55 in which Cu and Mg coexist in the second glass layer 52 may be the same as or different from that in the first glass layer 51.

When the regions 55 in which Cu and Mg coexist are present in the second glass layer 52, the regions 55 in which Cu and Mg coexist are preferably present near an interface between the first ferrite layer 41 and the second glass layer 52. More specifically, the regions 55 in which Cu and Mg coexist are preferably present within a distance of ⅕ or less of the thickness of the second glass layer 52 from the interface between the first ferrite layer 41 and the second glass layer 52, for example, within a distance of 20 μm or less from the interface between the first ferrite layer 41 and the second glass layer 52. The regions 55 in which Cu and Mg coexist may, although not necessarily, be present at a location beyond the above-described distance, for example, around the center of the second glass layer 52 in the thickness direction.

The second glass layer 52 is preferably made of a glass-ceramic material containing a glass material and a filler. The glass-ceramic material of the second glass layer 52 may be the same as or different from the glass-ceramic material of the first glass layer 51.

The thickness (dimension in the height direction T) of the second glass layer 52 may be the same as or different from the thickness of the first glass layer 51.

When the regions 55 in which Cu and Mg coexist are present in the third glass layer 53, the regions 55 in which Cu and Mg coexist are preferably scattered over the third glass layer 53. The regions 55 in which Cu and Mg coexist are uniformly scattered over the third glass layer 53 in FIG. 5, but may be non-uniformly scattered over the third glass layer 53.

When the regions 55 in which Cu and Mg coexist are present in the third glass layer 53, the sizes, shapes, etc. of the regions 55 in which Cu and Mg coexist are not particularly limited. However, a maximum width of the regions 55 in which Cu and Mg coexist is preferably 5 μm or less, more preferably 4 μm or less. A maximum width of the regions 55 in which Cu and Mg coexist is, for example, 0.5 μm or more. The maximum width of the regions 55 in which Cu and Mg coexist in the third glass layer 53 may be the same as or different from that in the first glass layer 51. The maximum width of the regions 55 in which Cu and Mg coexist in the third glass layer 53 may be the same as or different from that in the second glass layer 52.

When the regions 55 in which Cu and Mg coexist are present in the third glass layer 53, the regions 55 in which Cu and Mg coexist are preferably present near an interface between the second ferrite layer 42 and the third glass layer 53. More specifically, the regions 55 in which Cu and Mg coexist are preferably present within a distance of ⅕ or less of the thickness of the third glass layer 53 from the interface between the second ferrite layer 42 and the third glass layer 53, for example, within a distance of 20 μm or less from the interface between the second ferrite layer 42 and the third glass layer 53. The regions 55 in which Cu and Mg coexist may, although not necessarily, be present at a location beyond the above-described distance, for example, around the center of the third glass layer 53 in the thickness direction.

The third glass layer 53 is preferably made of a glass-ceramic material containing a glass material and a filler. The glass-ceramic material of the third glass layer 53 may be the same as or different from the glass-ceramic material of the first glass layer 51. The glass-ceramic material of the third glass layer 53 may be the same as or different from the glass-ceramic material of the second glass layer 52.

The thickness (dimension in the height direction T) of the third glass layer 53 may be the same as or different from the thickness of the first glass layer 51. The thickness of the third glass layer 53 may be the same as or different from the thickness of the second glass layer 52.

Each of the outer electrodes 30 is provided on the outer surface of the element body 10A to extend along the second glass layer 52, the first ferrite layer 41, the first glass layer 51, the second ferrite layer 42, and the third glass layer 53. In FIG. 4, a first outer electrode 31 and a third outer electrode 33 are provided on a first side surface 13a of the element body 10A, and a second outer electrode 32 and a fourth outer electrode 34 are provided on a second side surface 13b of the element body 10A. As illustrated in FIG. 4, each of the first outer electrode 31, the second outer electrode 32, the third outer electrode 33, and the fourth outer electrode 34 may be U-shaped (bracket shaped) and extend to a first principal surface 12a and a second principal surface 12b of the element body 10A.

The coil component 2 is, for example, manufactured similarly to the coil component 1 except that the step of producing the multilayer body block is performed as described below.

Step of Producing Multilayer Body Block

First, glass-ceramic sheets on which conductor patterns are formed are stacked in a lamination direction (height direction T in this example). A glass-ceramic sheet having no conductor pattern is stacked on one principal surface of the obtained multilayer body in the lamination direction (height direction in this example). Another glass-ceramic sheet having no conductor pattern may be stacked on the other principal surface of the obtained multilayer body in the lamination direction (height direction T in this example). The number of glass-ceramic sheets having no conductor pattern is not particularly limited.

Next, a predetermined number of ferrite sheets are stacked on each principal surface of the obtained multilayer body of the glass-ceramic sheets in the lamination direction (height direction T in this example). First ferrite sheets are stacked on one principal surface of the multilayer body of the glass-ceramic sheets, and second ferrite sheets are stacked on the other principal surface.

Subsequently, a predetermined number of glass-ceramic sheets having no conductor pattern are stacked on each of a multilayer portion composed of the first ferrite sheets and a multilayer portion composed of the second ferrite sheets in the lamination direction (height direction T in this example).

The obtained multilayer body of the glass-ceramic sheets and the ferrite sheets is subjected to pressure bonding by, for example, a warm isostatic pressing process to produce a multilayer body block.

After that, separate chips are produced in the step of producing the element body and the coils. Then, the separate chips are fired.

This specification discloses the following features:
<1> A coil component including an element body including a multilayer body in which a first ferrite layer, a first glass layer, and a second ferrite layer are laminated in that order; a coil embedded in the first glass layer; and an outer electrode provided on an outer surface of the element body and electrically connected to the coil. The first glass layer includes regions in which Cu and Mg coexist.
<2> The coil component according to <1>, wherein the regions in which Cu and Mg coexist being scattered over the first glass layer.
<3> The coil component according to <1> or <2>, wherein the regions in which Cu and Mg coexist have a maximum width of 5 μm or less.
<4> The coil component according to any one of <1> to <3>, wherein the element body further includes a second glass layer on an outer side portion of the first ferrite layer and a third glass layer on an outer side portion of the second ferrite layer.
<5> The coil component according to any one of <1> to <4>, wherein the first glass layer contains at least B, Si, and Mg.
<6> The coil component according to any one of <1> to <5>, wherein the first glass layer contains at least forsterite.
<7> The coil component according to any one of <1> to <6>, wherein the coil contains at least Ag.
<8> The coil component according to any one of <1> to <7>, wherein the outer electrode contains at least Ag.
<9> The coil component according to any one of <1> to <8>, wherein the coil is a common-mode choke coil including a first coil and a second coil embedded in the first glass layer.

### EXAMPLES

More specific examples of coil components according to the present disclosure will now be described. The present disclosure is not limited only to the examples described below.

### Example 1

Borosilicate glass powder containing K and Al, alumina powder, quartz powder, and forsterite powder were prepared. The borosilicate glass powder, the alumina powder, the quartz powder, and the forsterite powder were weighed in ratios of 77.5% by volume, 1.5% by volume, 11% by volume, and 10% by volume, respectively. Glass-ceramic sheets were produced by the method described above in the “Step of Producing Glass-Ceramic Material” section and the “Step of Producing Glass-Ceramic Sheets” section.

Fe₂O₃ powder, NiO powder, ZnO powder, and CuO powder were weighed in a predetermined ratio, and ferrite sheets were produced by the method described above in the “Step of Producing Ferrite Material” section and the “Step of Producing Ferrite Sheets” section.

Conductor patterns were formed by applying a paste to predetermined glass-ceramic sheets by the method described above in the “Step of Forming Conductor Patterns” section. Then, the glass-ceramic sheets were stacked together, and the first ferrite sheets and the second ferrite sheets were stacked on the glass-ceramic sheets from above and below, as in FIG. 3. Then, a multilayer body in an unfired state (chip) was produced by a procedure described above in the “Step of Producing Multilayer Body Block” section and the “Step of Producing Element Body and Coils” section.

The multilayer body in an unfired state was fired in a firing furnace at 910° C. for two hours to produce a fired multilayer body. The firing process was performed in an atmosphere in which the oxygen concentration was adjusted to 0.1% by volume.

A conductive paste containing Ag and glass was applied to the fired multilayer body at locations at which the outer electrodes were to be formed, and was maintained at 810° C. for one minute to form base electrodes. Next, a Ni plating electrode and a Sn plating electrode were successively formed on each base electrode by electrolytic plating. Thus, the outer electrodes including the base electrodes and the plating electrodes were formed.

Thus, a coil component serving as a sample of Example 1 was produced.

### Comparative Example 1

A coil component serving as a sample of Comparative Example 1 was produced by the same method as that in Example 1 except that the contents of the forsterite powder, the borosilicate glass powder, the alumina powder, and the quartz powder in the glass-ceramic sheets were 0% by volume, 86.1% by volume, 1.7% by volume, and 12.2% by volume, respectively, and that the firing process was performed in the atmosphere.

### Comparative Example 2

A coil component serving as a sample of Comparative Example 2 was produced by the same method as that in Example 1 except that the firing process was performed in the atmosphere.

The dimensions of the coil components serving as the samples of Example 1, Comparative Example 1, and Comparative Example 2 were 0.65 mm in the length direction L, 0.50 mm in the width direction W, and 0.30 mm in the height direction T.

Evaluation 1

After the formation of the base electrodes and before the formation of the plating electrodes, each sample of Example 1, Comparative Example 1, and Comparative Example 2 was placed upright such that the length direction L of the sample extended vertically, and was covered with a resin. Then, each sample was ground in the length direction L of the sample by using a grinder to a depth at which a substantially central portion of the sample in the length direction L was exposed.

A cross section (WT cross section) obtained as a result of the grinding process was subjected to Cu and Mg mapping by field emission wavelength-dispersive X-ray spectrometry (FE-WDX). JXA-8530F produced by JEOL Ltd. was used for FE-WDX. The analysis conditions are as follows.
Acceleration Voltage: 15.0 kV
Illumination Current: 5×10⁻⁸ A
Number of Pixels: 256×256
Pixel Size: 0.4 (magnification: 1000)
Dwell Time (Acquisition Time Per Pixel): 40 ms
Analysis Depth: 1 μm to 2 μm

The results of the Cu and Mg mapping analysis showed that, in the samples of Comparative Example 1 and Comparative Example 2, segregation of Cu occurred on the surfaces of the chips at locations near the interfaces between the ferrite layers and the glass layers. In addition, the glass layers had no regions in which Cu and Mg coexisted.

In the sample of Example 1, the glass layer included regions in which Cu and Mg coexisted. The regions in which Cu and Mg coexisted had a maximum width of 5 μm or less.

Evaluation 2

After the formation of the plating electrodes, the samples of Example 1, Comparative Example 1, and Comparative Example 2 were observed in regions around the outer electrodes by using a digital microscope (VHX-6000 produced by Keyence Corporation).

In the samples of Comparative Example 1 and Comparative Example 2, plating elongation of more than 30 μm occurred.

In the sample of Example 1, no plating elongation of more than 30 μm occurred.

In each of the samples of Comparative Example 1 and Comparative Example 2, the Cu component presumably diffused into the glass layer from the ferrite layers during firing of the multilayer body in an unfired state, and then moved to the surfaces of the multilayer body during baking of the base electrodes, thereby causing segregation of Cu on the surfaces of the multilayer body.

In the sample of Example 1, the Cu component diffused into the glass layer during firing of the multilayer body in an unfired state presumably formed regions in which the Cu component and Mg coexisted and were therefore suppressed from moving toward the surfaces of the multilayer body during baking of the base electrodes.

Although forsterite was added so that the glass layer contained Mg in Example 1, the glass layer is not limited to this. For example, MgO may be added as a raw material of the glass material.

What is claimed is:

1. A coil component comprising:
an element body including a multilayer body in which a first ferrite layer, a first glass layer, and a second ferrite layer are laminated in that order;
a coil embedded in the first glass layer; and
an outer electrode on an outer surface of the element body and electrically connected to the coil,
wherein the first glass layer includes regions in which Cu and Mg coexist.

2. The coil component according to claim 1, wherein
the regions in which Cu and Mg coexist are scattered over the first glass layer.

3. The coil component according to claim 2, wherein
the regions in which Cu and Mg coexist have a maximum width of 5 μm or less.

4. The coil component according to claim 1, wherein
the element body further includes a second glass layer on an outer side portion of the first ferrite layer and a third glass layer on an outer side portion of the second ferrite layer.

5. The coil component according to claim 1, wherein
the first glass layer includes at least B, Si, and Mg.

6. The coil component according to claim 1, wherein
the first glass layer includes at least forsterite.

7. The coil component according to claim 1, wherein
the coil includes at least Ag.

8. The coil component according to claim 1, wherein
the outer electrode includes at least Ag.

9. The coil component according to claim 1, wherein
the coil is a common-mode choke coil including a first coil and a second coil embedded in the first glass layer.

10. The coil component according to claim 2, wherein
the coil is a common-mode choke coil including a first coil and a second coil embedded in the first glass layer.

11. The coil component according to claim 3, wherein
the coil is a common-mode choke coil including a first coil and a second coil embedded in the first glass layer.

12. The coil component according to claim 4, wherein
the coil is a common-mode choke coil including a first coil and a second coil embedded in the first glass layer.

13. The coil component according to claim 5, wherein
the coil is a common-mode choke coil including a first coil and a second coil embedded in the first glass layer.

14. The coil component according to claim 6, wherein
the coil is a common-mode choke coil including a first coil and a second coil embedded in the first glass layer.

15. The coil component according to claim 7, wherein
the coil is a common-mode choke coil including a first coil and a second coil embedded in the first glass layer.

16. The coil component according to claim 8, wherein
the coil is a common-mode choke coil including a first coil and a second coil embedded in the first glass layer.
